(19) United States
(12) Patent Application Publication
(10) Pub. No.: US 2010/0290709 A1
(43) Pub. Date: Nov. 18, 2010

(54) METHOD AND APPARATUS FOR RECOGNIZING TYPES OF VEHICLES

(75) Inventors: Kung Ming LAN, Jiaoxi Township (TW); Jen Hui Chuang, Hsinchu City (TW)

Correspondence Address: EGBERT LAW OFFICES, 412 MAIN STREET, 7TH FLOOR, HOUSTON, TX, 77002, US

(73) Assignee: INDUSTRIAL TECHNOLOGY RESEARCH INSTITUTE, Chutung (TW)

(21) Appl. No.: 12/553,896

(22) Filed: Sep. 3, 2009

(30) Foreign Application Priority Data
May 12, 2009 (TW) 098115630

(51) Int. Cl. G06K 9/62; G06K 9/00

(52) U.S. Cl. 382/209; 382/181; 382/224

(57) ABSTRACT

Consistent with the disclosed embodiments, the shapes of the windows of vehicles are used as features for recognizing vehicle types. This method transforms vehicle images with different view angles in a homographic manner to a normalized coordinate system and further extracts normalized window images. Subsequently, the method recognizes target vehicle types correctly in accordance with the normalized window images.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The disclosure relates to a method and apparatus for recognizing types of vehicles.

2. Description of Related Art

Including Information Disclosed Under 37 CFR 1.97 and 37 CFR 1.98.

Vehicle recognition systems currently on the market are usually based on vehicle license plate recognition techniques. However, the vehicle license plate recognition techniques have several limitations. TW patent No. 1290696 discloses a digital surveillance system which uses both vehicle license plate numbers and vehicle features. The digital surveillance system is principally composed of an image capturing module, a vehicle license plate recognition module, a vehicle feature extraction module and a vehicle feature comparison module. In addition to a surveillance function provided by the digital surveillance system, different vehicle license plate numbers captured by the image capturing module and vehicle features extracted by the vehicle feature comparing module are used for further feature comparison processes. On the other hand, JP patent publication No. 7-167624 discloses a recognition system recording vehicle data with a design of a gateway together with a straight path. The vehicle data such as vehicle length, distance between wheels and distance between windows is utilized for recognizing the type of a vehicle.

However, it is difficult to recognize vehicle license plate number and vehicle type for vehicles moving on the road. In the past, suspicious vehicles could not be effectively identified in real time by police officers. Moreover, it is more difficult to track suspicious vehicles in a big city with complex road networks. In addition, due to curving streets and variations in road arrangements, it can be difficult for police to find a target vehicle. For example, at the scene of a traffic accident, even if a target vehicle has been confirmed, it may still be difficult to effectively locate the target vehicle driving in the complex road networks. Therefore, a vehicle type recognition method and apparatus utilizing effective features to recognize target vehicles correctly and speedily are needed.

### BRIEF SUMMARY OF THE INVENTION

A method and apparatus for recognizing types of vehicles is disclosed. The shapes of the windows of vehicles are used as recognizing features. This method transforms vehicle images with different view angles in a homographic manner to a normalized coordinate system and further extracts normalized window images. Subsequently, the method recognizes target vehicles correctly in accordance with the normalized window images.

According to one exemplary embodiment, an apparatus for recognizing types of vehicles comprises an image acquiring unit, a feature extracting unit, a recognizing unit and a database. The image acquiring unit is utilized for acquiring at least one image of a vehicle. The feature extracting unit is utilized for extracting at least one window image from the at least one image of the vehicle. The recognizing unit is utilized for recognizing the at least one window image. The recognizing unit recognizes the window image in accordance with the images stored in the database. The database is utilized for storing the at least one window image.

According to another exemplary embodiment, an apparatus for recognizing types of vehicles comprises an image acquiring unit, a homography transforming unit, a feature extracting unit, a recognizing unit and a database. The image acquiring unit is utilized for acquiring at least one image of a vehicle. The homography transforming unit is utilized for transforming the at least one image of the vehicle to a normalized coordinate system to obtain a transformed vehicle image. The feature extracting unit is utilized for extracting at least one window image from the transformed vehicle image. The recognizing unit is utilized for recognizing the at least one window image. The recognizing unit recognizes the at least one window image in accordance with the images stored in the database. The database is utilized for storing the at least one window image.

According to another embodiment, a method for recognizing types of vehicles comprises: acquiring an image of a vehicle; extracting at least one window image from the image of the vehicle; and recognizing the at least one window image.

According to another embodiment, a method for recognizing types of vehicles comprises: acquiring an image of a vehicle; transforming the image of the vehicle to a normalized coordinate system to obtain a transformed vehicle image; extracting at least one window image from the transformed vehicle image; and recognizing the at least one window image.

### BRIEF DESCRIPTION OF THE SEVERAL VIEWS OF THE DRAWINGS

The accompanying drawings, which are incorporated in and constitute a part of this specification, illustrate embodiments of the disclosure and, together with the description, serve to explain the principles of the invention.

FIG. 1 shows a diagram of an apparatus for recognizing types of vehicles in accordance with an exemplary embodiment.

FIG. 2 shows a flowchart of a method for recognizing types of vehicles in accordance with another exemplary embodiment.

FIG. 3 shows a schematic view of a side image of a vehicle in accordance with an exemplary embodiment.

FIG. 4 shows a diagram of an apparatus for recognizing types of vehicles in accordance with another exemplary embodiment.

FIG. 5 shows a flowchart of a method for recognizing types of vehicles in accordance with another exemplary embodiment.

### DETAILED DESCRIPTION OF THE INVENTION

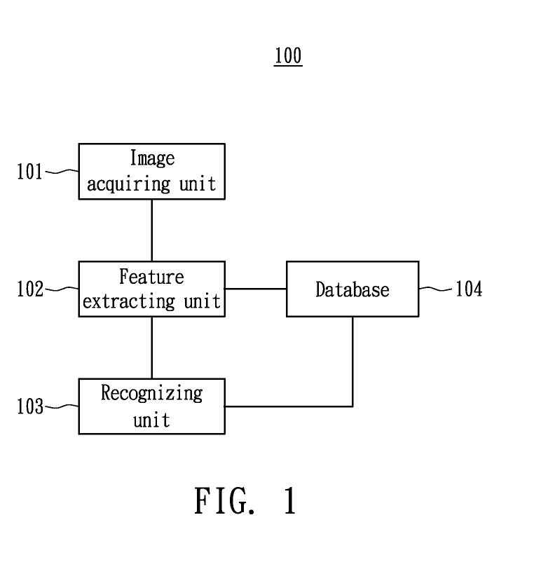

FIG. 1 shows a diagram of an apparatus for recognizing types of vehicles in accordance with an exemplary embodiment. The apparatus 100 for recognizing types of vehicles comprises an image acquiring unit 101, a feature extracting unit 102, a recognizing unit 103 and a database 104. The image acquiring unit 101 is utilized for acquiring at least one image of a vehicle. The feature extracting unit 102 is utilized for extracting at least one window image from the image of the vehicle, wherein the window image is a window shape image or a window frame image. The recognizing unit 103 is utilized for recognizing the window image. The database 104 is utilized for storing the window image. The recognizing unit 103 recognizes the window image in accordance with the images stored in the database 104.

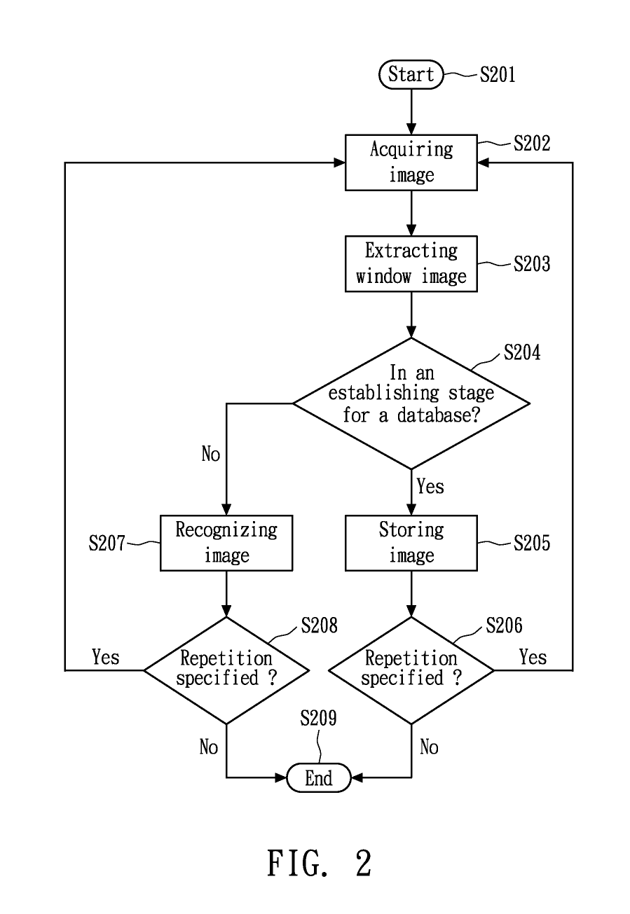

FIG. 2 shows a flowchart of a method for recognizing types of vehicles in accordance with another exemplary embodiment. FIGS. 1-3 are used to describe exemplary embodiment of the procedure of the method for recognizing types of vehicles. In step S201, the procedure of the embodiment is activated. In step S202, the image acquiring unit 101 is utilized for acquiring an image of a vehicle, wherein the image of the vehicle is a side-view image of the vehicle.

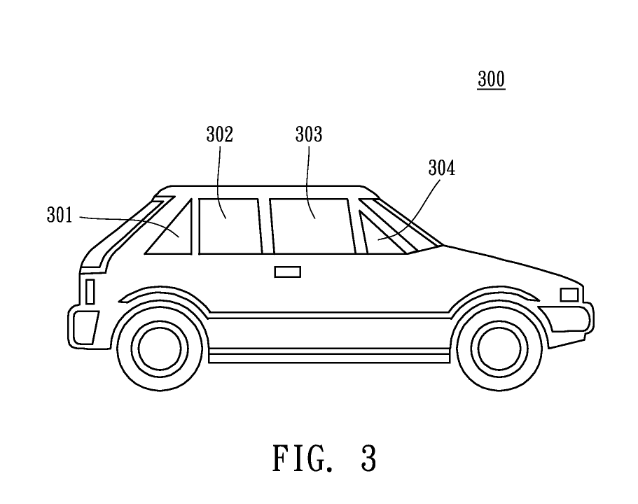

FIG. 3 shows a side-view image of a vehicle in accordance with the exemplary embodiment. In step S203, the feature extracting unit 102 is utilized for extracting at least one window image from the side-view image. The window image is used as a recognizing feature for the vehicle type to which the vehicle belongs. In accordance with the exemplary embodiment, any of windows 301-304 or the combination thereof can be used as a recognizing feature for the vehicle type to which the vehicle belongs. Persons skilled in the art realize that an image recognition procedure includes an establishing stage for a database and a real surveillance stage. In an establishing stage for a database, target images are stored in the database by a recognition system. Subsequently, in the real surveillance stage, a determination is performed in accordance with the target images stored in the database. Therefore, step S204 determines whether the process is currently in an establishing stage for the database. If YES, the window image is stored in the database 104 in step S205. If NO, the window image is recognized in accordance with the images stored in the database 104 in step S207. Step S206 determines whether steps S202-S205 are to be repeated for the establishing stage. If NO, the procedure is ended in step S209. Step S208 determines whether steps S202-S204 and S207 are to be repeated for the real surveillance stage. If NO, the procedure is ended in step S209.

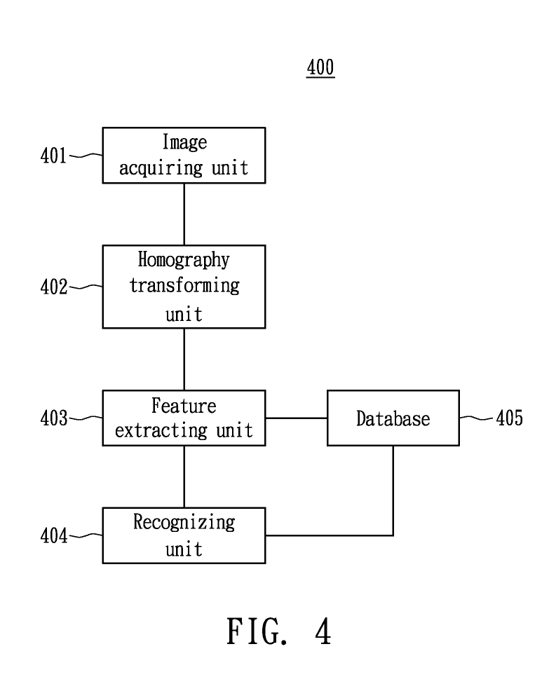

If a side-view image with different view angle is acquired by an image acquiring unit for a vehicle, a window image selected from the side-view image as a feature image is transformed to a normalized coordinate system by an apparatus for recognizing types of vehicles to obtain a transformed vehicle image (normalized image). FIG. 4 shows a diagram of an apparatus for recognizing types of vehicles in accordance with another exemplary embodiment. The apparatus 400 for recognizing types of vehicles comprises an image acquiring unit 401, a homography transforming unit 402, a feature extracting unit 403, a recognizing unit 404 and a database 405. The image acquiring unit 401 is utilized for acquiring at least one image of a vehicle. The homography transforming unit 402 is utilized for transforming the image of the vehicle to a normalized coordinate system to obtain a transformed vehicle image. The feature extracting unit 403 is utilized for extracting at least one window image from the transformed vehicle image, wherein the window image is a window shape image or a window frame image. The recognizing unit 404 is utilized for recognizing the window image. The database 405 is utilized for storing the window image. The recognizing unit 404 recognizes the window image in accordance with the images stored in the database 405. The above-mentioned image acquiring units 101, 401 are visible light image acquiring units or infrared image acquiring units. The feature extracting units 102, 403 and recognizing units 103, 404 can be implemented with software, firmware, hardware, a platform with single processor, or a platform with multiple processors.

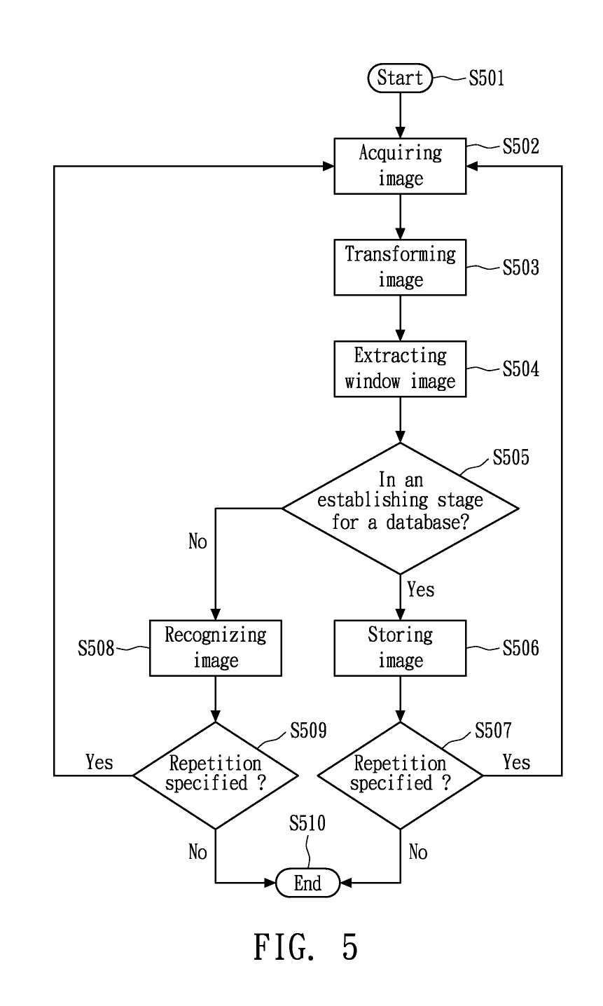

FIG. 5 shows a flowchart of a method for recognizing types of vehicles in accordance with another exemplary embodiment. FIGS. 4 and 5 are used to describe exemplary embodiment of the procedure of the method for recognizing types of vehicles. In step S501, the procedure of the embodiment is activated. In step S502, the image acquiring unit 401 is utilized for acquiring an image of a vehicle. In step S503, in accordance with corner points of a window image selected as a feature image, the image of the vehicle is homographically transformed to a normalized coordinate system by the homography transforming unit 402 for obtaining a transformed vehicle image. In step S504, the feature extracting unit 403 is utilized for extracting the window image selected as the feature image from the transformed vehicle image. Step S505 determines whether the process is currently in an establishing stage for the database. If YES, the window image is stored in the database 405 in step S506. If NO, the window image is recognized in accordance with the images stored in the database 405 in step S508. Step S507 determines whether steps S502-S506 are to be repeated for the establishing stage. If NO, the procedure is ended in step S510. Step S509 determines whether steps S502-S505 and S508 are to be repeated for the real surveillance stage. If NO, the procedure is ended in step S510.

The above-described exemplary embodiments are intended to be illustrative the invention principle only. Those skilled in the art may devise numerous alternative embodiments without departing from the scope of the following claims.

1. An apparatus for recognizing types of vehicles, comprising:
an image acquiring unit configured to acquire at least one image of a vehicle;
a feature extracting unit configured to extract at least one window image from the at least one image of the vehicle; and
a recognizing unit configured to recognize the at least one window image.

2. The apparatus of claim 1, further comprising:
a database configured to store said at least one window image.

3. The apparatus of claim 2, wherein the recognizing unit recognizes the at least one window image in accordance with images stored in the database.

4. The apparatus of claim 1, wherein the at least one window image is comprised of a window shape image or a window frame image.

5. The apparatus of claim 1, wherein the image acquiring unit is comprised of a visible light image acquiring unit or an infrared image acquiring unit.

6. The apparatus of claim 1, wherein the feature extracting unit and the recognizing unit are implemented with software, firmware, hardware, a platform with a single processor, or a platform with multiple processors.

7. An apparatus for recognizing types of vehicles, comprising:
an image acquiring unit configured to acquire at least one image of a vehicle;
a homography transforming unit configured to transform the at least one image of the vehicle to a normalized coordinate system to obtain at least one transformed vehicle image;
a feature extracting unit configured to extract at least one window image from the at least one transformed vehicle image; and
a recognizing unit configured to recognize the at least one window image.

8. The apparatus of claim 7, further comprising:
a database configured to store said at least one window image.

9. The apparatus of claim 8, wherein the recognizing unit recognizes the at least one window image in accordance with images stored in the database.

10. The apparatus of claim 7, wherein the at least one window image is comprised of a window shape image or a window frame image.

11. The apparatus of claim 7, wherein the image acquiring unit is comprised of a visible light image acquiring unit or an infrared image acquiring unit.

12. The apparatus of claim 7, wherein the feature extracting unit and the recognizing unit are implemented with software, firmware, hardware, a platform with single processor, or a platform with multiple processors.

13. A method for recognizing types of vehicles, comprising:
acquiring an image of a vehicle;
extracting at least one window image from the image of the vehicle; and
recognizing the at least one window image.

14. The method of claim 13, further comprising:
storing the at least one window image to a database.

15. The method of claim 14, wherein the least one window image is recognized in accordance with images stored in the database.

16. The method of claim 13, wherein the at least one window image is comprised of a window shape image or a window frame image.

17. A method for recognizing types of vehicles, comprising:
acquiring an image of a vehicle;
transforming the image of the vehicle to a normalized coordinate system to obtain a transformed vehicle image;
extracting at least one window image from the transformed vehicle image; and
recognizing the at least one window image.

18. The method of claim 17, wherein the image of the vehicle is homographically transformed to the normalized coordinate system to obtain the transformed vehicle image.

19. The method of claim 17, further comprising:
storing the at least one window image to a database.

20. The method of claim 19, wherein the least one window image is recognized in accordance with images stored in the database.

21. The method of claim 13, wherein the at least one window image is comprised of a window shape image or a window frame image.
